(19) United States
(12) Patent Application Publication
(10) Pub. No.: US 2016/0055617 A1
(43) Pub. Date: Feb. 25, 2016

(54) Method for Correcting the Perspective of an Image of an Electronic Device

(71) Applicant: Motorola Mobility LLC, Chicago, IL (US)

(72) Inventor: Michael David McLaughlin, San Jose, CA (US)

(21) Appl. No.: 14/463,686

(22) Filed: Aug. 20, 2014

(51) Int. Cl. G06T 3/00

(52) U.S. Cl. CPC G06T 3/0012; G06T 3/0093

(57) ABSTRACT

This disclosure is generally directed to a method for correcting the perspective of an image. According to various embodiments, the method, which is carried out on an electronic device having a display, involves mapping logical pixels of the image to physical pixels of the display based on the expected viewing angle of the location (e.g., the screen location) of the display at which the logical pixels are to be rendered. The effect of this mapping, according to various embodiments, is to make the apparent size of certain portions of the image larger in order to correct for perspective distortion caused by the viewing angle at which the image is viewed.

### TECHNICAL FIELD

The present disclosure is related generally to wireless communication devices and, more particularly, to methods for correcting perspective on an electronic device.

### BACKGROUND

Traditionally, video displays (e.g., smartphone screens) render images under the assumption that the viewer will look at the image orthogonally. That is, the viewer will generally perceive each portion of the display as orthogonal to the plane of the viewer's line of sight. However, with the advent of newer types of electronic devices, such as wearable devices (e.g., smart watches), and with the introduction of so-called flexible displays, this assumption may no longer be valid.

### DRAWINGS

While the appended claims set forth the features of the present techniques with particularity, these techniques, together with their objects and advantages, may be best understood from the following detailed description taken in conjunction with the accompanying drawings of which:

FIG. 1A is a frontal view of an electronic device according to an embodiment;

FIG. 1B is a side view of the electronic device of FIG. 1A;

FIG. 1C is a frontal view of the electronic device of FIG. 1A after a perspective correction method has been applied, according to an embodiment;

FIG. 2 is a block diagram depicting components of an electronic device according to an embodiment;

FIG. 3 is a textual view of a data structure (populated with example data) according to an embodiment; and

FIG. 4, FIG. 5, and FIG. 6 show process flow diagrams that illustrate the operation of different embodiments.

### DESCRIPTION

As used herein, the term “image” includes a still image, moving image, portion of a still image, and portion of a moving image, including an image (e.g., windows, text, menus, buttons, and icons) rendered by a graphical user interface. Also, as used herein, the term “mapping” refers to an operation that associates an element of a given set (e.g., a set of logical pixels) with one or more elements of a second set (e.g., a set of physical pixels).

This disclosure is generally directed to a method for correcting the perspective of an image. According to various embodiments, the method, which is carried out on an electronic device having a display, involves mapping logical pixels of the image to physical pixels of the display based on the expected viewing angle of the location (e.g., the screen location) of the display at which the logical pixels are to be rendered. In one embodiment, the electronic device maps a first set of logical pixels of the image to a first set of physical pixels of the display at a first ratio (e.g., number of logical pixels per physical pixel) and maps a second set of logical pixels of the image to a second set of physical pixels of the display at a second ratio, which is different from the first ratio. The effect of this mapping, according to various embodiments, is to make the apparent size of certain portions of the image larger in order to correct for perspective distortion caused by the viewing angle at which the image is viewed.

In various embodiments, the electronic device applies perspective correction to purposefully distort the “correct” image data as it is rendered by the device such that the image appears to be non-distorted to the user when the user is viewing the image and interacting with the electronic device at a non-orthogonal angle. In other words, the non-orthogonal viewing angle naturally distorts the image (e.g., the shapes and angles). Thus, the electronic device compensates for this distortion by “distorting” the image in the opposite way. In one embodiment, the electronic device carries out perspective correction by rasterizing logical pixels of an image in a non-square, non-equal manner onto physical pixels of the display.

In some embodiments, when a user views the display at a non-orthogonal angle (i.e., oblique), the images (if uncorrected) appear dimmer and bluer to the user. The approximate distortion caused by the display is known in advance and is based on (1) the shape of the surface of the display, and (2) on the expected viewing angle of the display to the user when the electronic device is in the most comfortable position with respect to the user. Based on these factors, the electronic device can digitally adjust the logical pixels as a function of their screen position, then render them unequally using physical pixels. The content itself need not be modified. Thus, photos, videos, maps, and apps need not be changed. For example, a look-up table (“LUT”) that matches the angles of the display can be predefined, stored in memory, and subsequently used by the electronic device.

In an embodiment, the electronic device maps each logical pixel (of all or a portion of the image) to a physical pixel on the display and sets a value for one or more of the luminance, chrominance, and reflectance of the physical pixel based on the expected viewing angle of the viewing surface at which the physical pixel is located (e.g., brightens the pixels for those surfaces that are expected to be oblique to the plane of the user's view and dims or leaves unmodified the pixels for those surfaces that are expected to be orthogonal to the plane of the user's view). The electronic device then renders the logical pixel on the display using the physical pixel. These procedures can make the luminance and color of the image appear more uniform to the user.

In an embodiment, some logical pixel values may remain unmodified (i.e., the logical pixel is rendered onto the physical pixel using the same values specified by the logical pixel), some may modified together (e.g., all of the red luminance (“R”), green luminance (“G”), blue luminance (“B”), and reflectance values are increased or decreased by the same amount to increase or decrease the overall luminance or reflectance), and some may be modified differently from others (e.g., the B value is reduced more than the R or G values in order to prevent a blue-shift of the physical pixel).

In some embodiments, the electronic device maps each logical pixel (of all or a portion of the image) to a physical pixel on the display and sets a value for one or more of the luminance, chrominance, and reflectance of the physical pixel based on the determined current viewing angle of the viewing surface of the display on which the physical pixel is located. In various implementations, the electronic device uses sensors, such as gyroscopic sensors, to detect the angle of the display or a camera (e.g., an infrared camera) to track the user's eyes or gaze when looking at the screen. The electronic device may, for example, dynamically adjust LUT values for physical pixel location to alter the adjustment as the user moves the device (e.g., moves his or her arm while viewing a smart watch).

In some embodiments, the electronic device may be configured so that the various correction techniques described herein could be adjusted by, and turned on or off by a user. In some embodiments, the device itself may initiate one or more of these correction techniques. For example, when the device shows certain content (e.g., a movie) the device could automatically make corrections, and could subsequently turn the corrections off for other content.

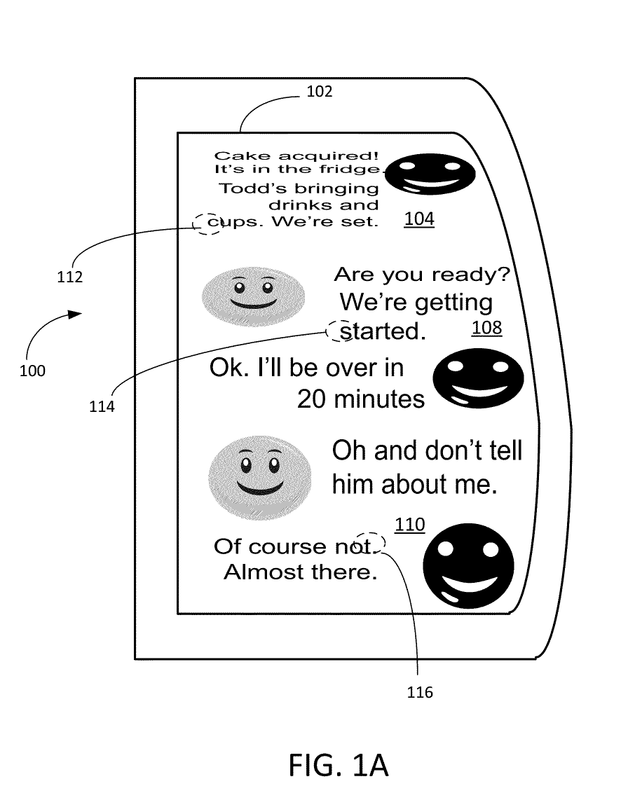

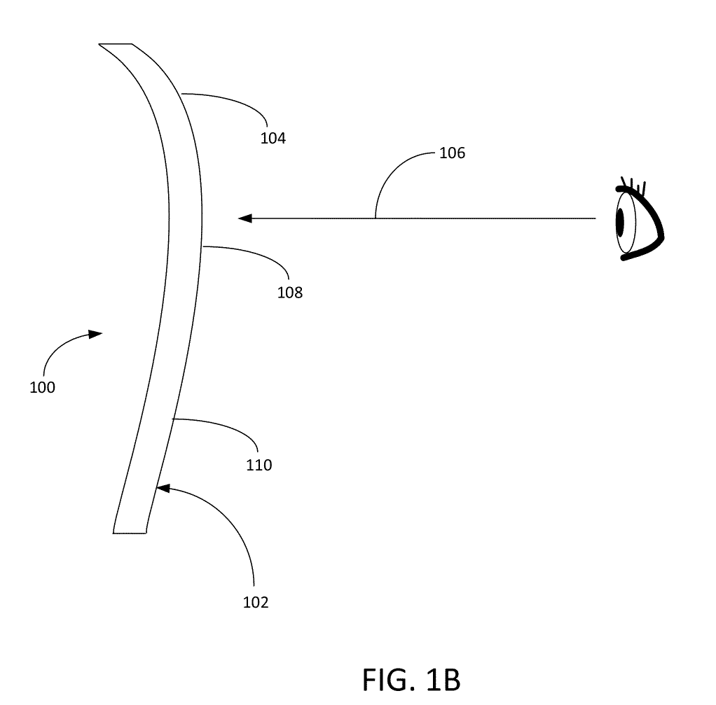

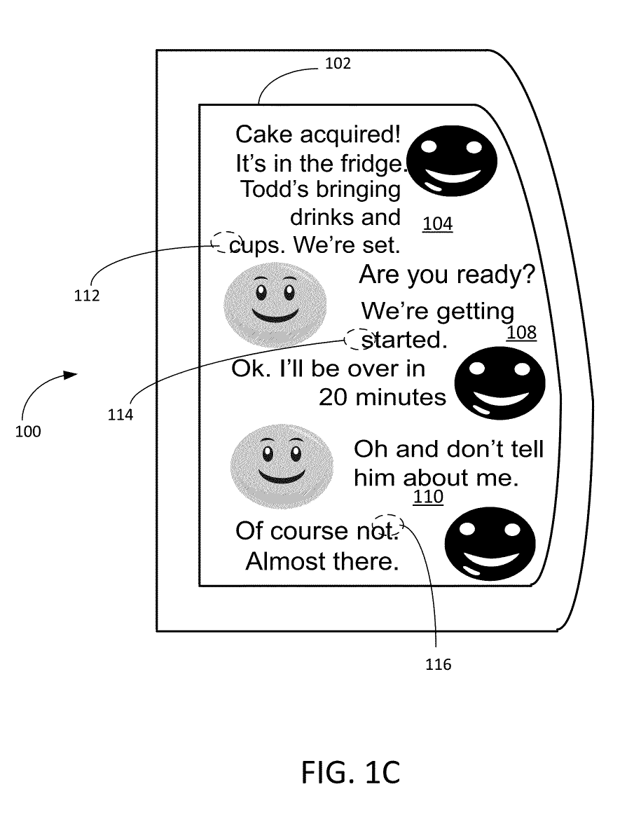

Turning to FIGS. 1A, 1B, and 1C, an electronic device 100 (“device 100”) according to an embodiment is shown. Although depicted as a smart watch, other possible implementations of the device 100 include a smart phone, a tablet computer, portable gaming device, or any other device that includes a display that is expected to have a non-orthogonal viewing angle (i.e., a viewing surface that is not orthogonal to the plane in which the user is viewing the surface) during normal use.

The device 100 includes a display 102. In one embodiment the device 100 is a smart watch and the display 102 wraps around the user's wrist when the device 100 is worn. Thus, when a user looks at the device 100 in a typical fashion, different portions of the display 102 are (and are perceived to be) at different angles with respect to the user's line of sight than other portions. For example, a first region 104 of the display 102 is at a first angle with respect to the user's line of sight 106, a second region 108 is at a second angle with respect to the user's line of sight 106, and a third region 110 is at a third angle with respect to the user's line of sight 106.

The display 102 is organized into physical pixels including a first physical pixel set 112 in the first region 104, a second physical pixel set 114 in the second region 108, and a third physical pixel set 116 in the third region 110. Each set of pixels may contain multiple pixels or a single pixel. As discussed below in further detail, the device 100 maps logical pixels of an image onto the physical pixels.

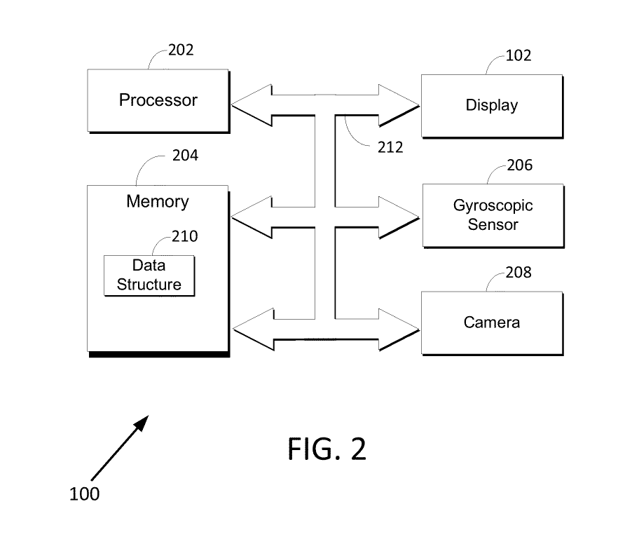

Turning to FIG. 2, the electronic device 100 in an embodiment includes a processor 202. Several components are communicatively linked to the processor 202, including the display 102, a memory 204, a gyroscopic sensor 206 that senses orientation (e.g., of the display 102), and a camera 208 (e.g., an infrared camera). Stored in the memory 204 is a data structure 210. The data structure 210 includes a mapping of the logical pixels to physical pixels for the display 102. The data structure 210 may be implemented in many different ways, including as one or more LUTs, and may be one of multiple data structures in the memory 204 that include such a mapping. The data structure 210, in one embodiment, indicates the ratio of logical pixels to physical pixels. This ratio may vary from location to location on the display 102. In another embodiment, the data structure 210 indicates changes to be made to the luminosity of logical pixels of an image when the image is rendered onto the physical pixels. The changes (including, in some cases, absence of change) may vary from location to location on the display 102. In still another embodiment, the data structure 210 indicates changes to be made to the chrominance of the logical pixels of an image when the image is rendered onto the physical pixels. The changes (including, in some cases, absence of change) may vary from location to location on the display 102.

In some embodiments, the device 100 uses orientation data from the gyroscopic sensor 206 to alter the mapping of logical pixels to physical pixels. For example, the device 100 may modify the data structure 210 based on the angle at which the device 100 is oriented in order compensate for perspective based on the user's angle of view. In other embodiments, the device 100 uses data from the camera 208 to alter the mapping of logical pixels to physical pixels. For example, the camera 208 may indicate where the user is looking and the device 100 may modify the data structure 210 based on the direction of the user's gaze.

The device 100 may include other components that are not depicted, such as wireless networking hardware (e.g., a WiFi chipset or a cellular baseband chipset), through which the device 100 communicates with other devices over networks such as WiFi networks or cellular networks or short range communication hardware (e.g., a Bluetooth® chipset), through which the device 100 communicates with a companion device (e.g., the device 100 is a smart watch and communicates with a paired cell phone). The elements of FIG. 2 are communicatively linked to one another via one or more data pathways 212. Possible implementations of the data pathways 212 include wires and conductive pathways on a microchip. Possible implementations of the processor 202 include a general purpose microprocessor, a dedicated graphics processor, and a controller.

The processor 202 retrieves instructions from the memory 204 and operates according to those instructions to carry out various functions, including the methods described herein. Thus, when this disclosure refers to the device 100 carrying out an action, it is, in many embodiments, the processor 202 that actually carries out the action (in coordination with other pieces of hardware of the device 100 as necessary).

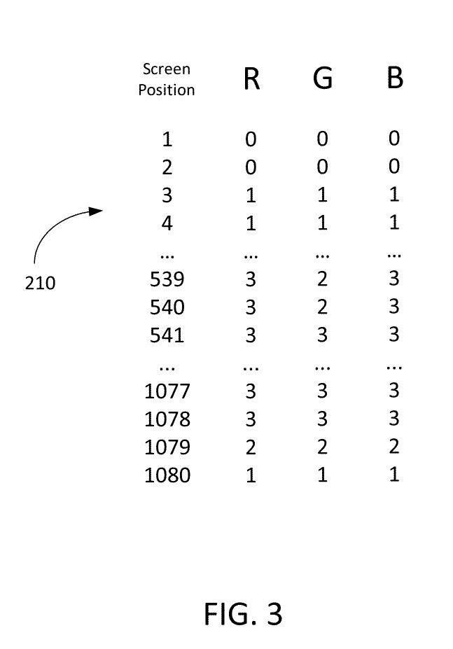

Turning to FIG. 3, an embodiment of the data structure 210 is an LUT of digital correction values that have been generated based on the expected viewing angle of the display 102. The leftmost column is a screen position. In some embodiments, the screen position is a location on the display 102 at which a logical pixel is to be rendered. In other embodiments, the screen position is a location on the display 102 at which a physical pixel is to be used for rendering one or more logical pixels. In order to use the data structure 210 in an embodiment, the processor 202 carries out the following procedure. First, for a given logical pixel, the processor 202 subtracts the value from the R, G and B values as indicated in the corresponding columns. Second, the processor 202 send adjusted logical pixel value to a graphics rasterization process (e.g., to a graphics processor). Note that instead of values to be subtracted, the data structure 210 could contain values to be added or look-up values (e.g., 0-255 entries). Also note that some embodiments do not use an LUT for mapping but rather use a general equation applied to the rendered pixels—e.g., Bezier curves of relative pixel adjustment as a function of pixel location (position) along the raster—in order to carry out such mapping.

Also note that the data structure 210 does not necessarily replace the typical LUT that are commonly used by graphics processing systems. In fact, both the data structure 210 and the typical LUT could be combined into a larger, common LUT indexed by screen position and pixel value.

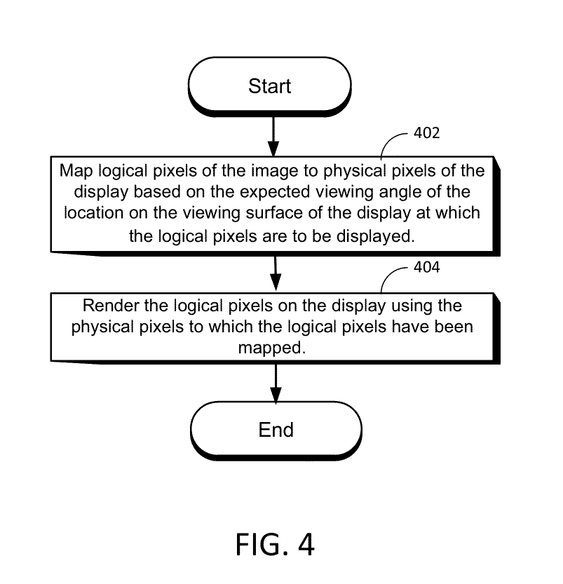

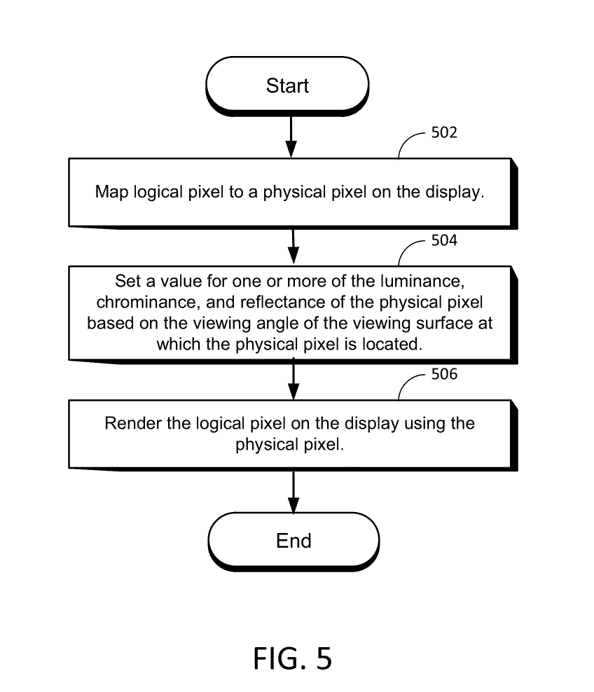

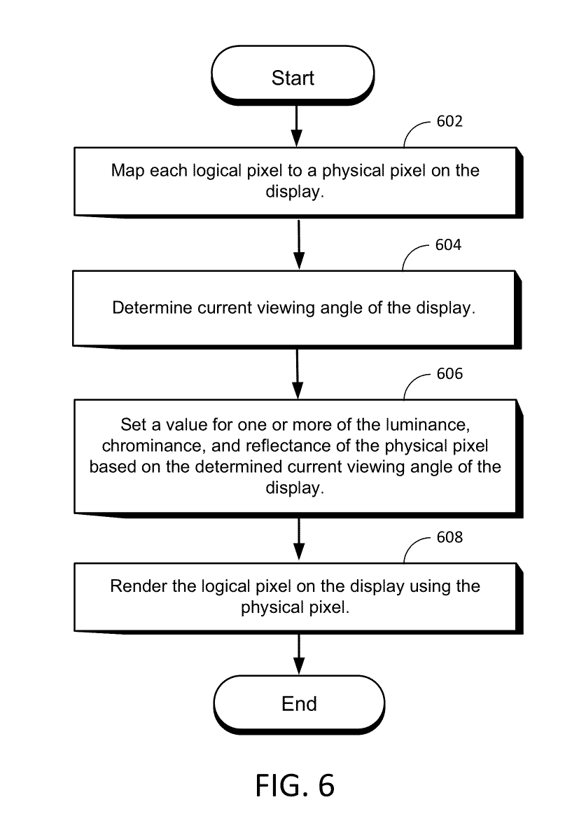

Turning to FIG. 4, a process carried out by the electronic device 100 according to an embodiment is described. At block 402, the processor 202 maps logical pixels of the image to physical pixels of the display 102 based on the expected viewing angle of the location on the viewing surface of the display at which the logical pixels are to be displayed. For example, prior to block 402, the processor 202 could map all logical pixels at a ratio of two logical pixels in height for every one physical pixel in height, and two logical pixels in width for every one physical pixel in width. If rendered on the display 102, such a mapping might look like that shown in FIG. 1A. As a result of performing block 402, however, the processor 202 might map (1) a first logical pixel set to the first physical pixel set 112 at a ratio of three logical pixels in height for every physical pixel in height, but keep the same ratio for width, and (2) a third logical pixel set to the third physical pixel set 116 at a ratio of three logical pixels in height for every two physical pixels in height, but keep the same ratio for width. Additionally, as a result of performing block 402, the processor 202 might not make any changes to the logical to physical pixel mapping for a second logical pixel set to the second physical pixel set 114 or may even make decrease the size of the image slightly (e.g., by increasing the number of logical pixels per physical pixel in either or both height and width). At block 404, the processor 202 renders the logical pixels on the display 102 using the physical pixels to which the logical pixels have been mapped. The modified mapping might result in an image that looks like that shown in FIG. 1C.

Turning to FIG. 5, a process carried out by the electronic device 100 according to another embodiment is described. For each logical pixel (out of some or all logical pixels of an image), at block 502, the processor 202 maps the logical pixel to a physical pixel on the display 102. At block 504, the processor 202 sets a value for one or more of the luminance, chrominance, and reflectance of the physical pixel based on the expected viewing angle of the viewing surface of the display on which the physical pixel is located. For example, the processor 202 might increase the luminance of the first physical pixel set 112 and the third physical pixel set 116, and decrease or leave unaltered the luminance of the second physical pixel set 114. At block 506, the processor 202 renders the logical pixel on the display using the physical pixel.

Turning to FIG. 6, a process carried out by the electronic device 100 according to another embodiment is described. For some or all logical pixels of an image, at block 602, the processor 202 maps each logical pixel to a physical pixel on the display. At block 604, the processor 202 determines (e.g., estimates) the current viewing angle of the display 102 (e.g., by using data from the gyroscopic sensor 206 or from the camera 208 as noted previously). At block 606, the processor 202 sets a value for one or more of the luminance, chrominance, and reflectance of the physical pixel based on the determined viewing angle. For example, the processor 202 might decrease the blue luminance of the first physical pixel set 112 and the third physical pixel set 116, and leave unaltered the blue luminance of the second physical pixel set 114. At block 608, the processor 202 renders the logical pixel on the display using the physical pixel.

In view of the many possible embodiments to which the principles of the present discussion may be applied, it should be recognized that the embodiments described herein with respect to the drawing figures are meant to be illustrative only and should not be taken as limiting the scope of the claims. Furthermore, it should be understood that the procedures set forth in the process flow diagrams may be reordered or expanded without departing from the scope of the claims. For example, blocks 602 and 604 of FIG. 6 may be reversed in order. Therefore, the techniques as described herein contemplate all such embodiments as may come within the scope of the following claims and equivalents thereof.

We claim:

1. On an electronic device comprising a display, a method for correcting the perspective of an image, the method comprising:
mapping logical pixels of the image to physical pixels of the display based on the expected viewing angle of the location on the viewing surface of the display on which the logical pixels are to be rendered; and
rendering the logical pixels on the display using the physical pixels to which the logical pixels have been mapped.

2. The method of claim 1, wherein mapping logical pixels of the image comprises:
mapping a first set of logical pixels of the image to a first set of physical pixels of the display at a first ratio; and
mapping a second set of logical pixels of the image to a second set of physical pixels of the display at a second ratio,
wherein the first ratio is different from second ratio.

3. The method of claim 2, wherein the first or second set of logical pixels includes only a single logical pixel.

4. The method of claim 2, wherein the first or second set of physical pixels includes only a single physical pixel.

5. The method of claim 1, wherein mapping logical pixels of the image comprises:
on a portion of the display that is at a first viewing angle, mapping the logical pixels of the image to physical pixels of the display so as to increase the apparent size of a portion of the image.

6. The method of claim 1, wherein mapping logical pixels of the image comprises:
on a portion of the display that is at a first viewing angle, mapping the logical pixels of the image to physical pixels of the display so as to decrease the apparent size of a portion of the image.

7. The method of claim 1, further comprising:
sensing an orientation of the electronic device; and
changing the mapping based on the sensed orientation.

8. The method of claim 1, further comprising:
sensing a user's gaze; and
changing the mapping based on the sensed gaze.

9. On an electronic device comprising a display, a method for correcting the perspective of an image, the method comprising:
for each of a plurality of logical pixels of the image, mapping the logical pixel to a physical pixel on the display;
setting a value for one or more of the luminance, chrominance, and reflectance of the physical pixel based on the viewing angle of the viewing surface on which the physical pixel is located; and
rendering the logical pixel on the display using the physical pixel.

10. The method of claim 9, further comprising:
mapping a first set of logical pixels of the image to a first set of physical pixels of the display at a first luminance; and
mapping a second set of logical pixels of the image to a second set of physical pixels of the display at a second luminance,
wherein the first luminance is different from the second luminance.

11. The method of claim 10, wherein the first or second set of logical pixels includes only a single logical pixel.

12. The method of claim 10, wherein the first or second set of physical pixels includes only a single physical pixel.

13. The method of claim 9, further comprising:
mapping a first set of logical pixels of the image to a first set of physical pixels of the display at a first chrominance; and
mapping a second set of logical pixels of the image to a second set of physical pixels of the display at a second chrominance,
wherein the first chrominance is different from the second chrominance.

14. The method of claim 13, wherein the first or second set of logical pixels includes only a single logical pixel.

15. The method of claim 13, wherein the first or second set of physical pixels includes only a single physical pixel.

16. The method of claim 9, wherein mapping logical pixels of the image comprises:
mapping a first set of logical pixels of the image to a first set of physical pixels of the display at a first reflectance; and
mapping a second set of logical pixels of the image to a second set of physical pixels of the display at a second reflectance,
wherein the first reflectance is different from the second reflectance.

17. The method of claim 16, wherein the first or second set of logical pixels includes only a single logical pixel.

18. The method of claim 16, wherein the first or second set of physical pixels includes only a single physical pixel.

19. On an electronic device comprising a display, a method for correcting the perspective of an image, the method comprising:
for each of a plurality of logical pixels of the image, mapping the logical pixel to a physical pixel on the display;
determining the current viewing angle of the display;
setting a value for one or more of the luminance, chrominance, and reflectance of the physical pixel based on the determined current viewing angle of a viewing surface of the display on which the physical pixel is located; and
rendering the logical pixel on the display using the physical pixel.

20. The method of claim 19, wherein determining the current viewing angle comprises:
receiving data from one or more of a gyroscopic sensor and a camera; and
determining the current viewing angle based on the received data.
